(19) United States
(12) Patent Application Publication
(10) Pub. No.: US 2026/0216677 A1
(43) Pub. Date: Jul. 30, 2026

(54) FEED NOZZLE ASSEMBLY

(71) Applicant: SHELL USA, INC., Houston, TX (US)

(72) Inventors: Robert Alexander LUDOLPH, Houston, TX (US); Eric OLDHAM, Houston, TX (US); Mohammad Umer ANSARI, Houston, TX (US); Cuong LE, Houston, TX (US)

(21) Appl. No.: 19/148,475

(22) PCT Filed: Feb. 6, 2024
(86) PCT No.: PCT/US2024/014533

§ 371 Date: Jul. 16, 2025

Related U.S. Application Data
(60) Provisional application No. 63/483,597, filed on Feb. 7, 2023.

(51) Int. Cl. B01J 4/00; B01J 6/00; B01J 8/18; B01J 19/02

(52) U.S. Cl. CPC B01J 4/002; B01J 6/008; B01J 8/1818; B01J 19/02; B01J 2208/00495

(57) ABSTRACT

A feed nozzle assembly for co-currently introducing vapor and liquid into a reactor vessel which feed nozzle assembly includes: (a) an annular enclosure surrounding an annular feed conduit, (b) an atomizing vapor conduit surrounded by the annular feed conduit. The annular feed conduit includes a first portion having a first outlet and a second portion having a second outlet opposite the first outlet. The first outlet fluidly connects the first portion and the second portion. The second portion is lined with a non-metallic conduit. The second outlet of the annular feed conduit traverses the annular enclosure. The atomizing vapor conduit has an outlet end having one or more openings disposed upstream of the first outlet of the annular feed conduit.

### TECHNICAL FIELD

The invention relates to a feed nozzle for co-currently introducing a gas and a liquid into a reactor vessel, particularly for introducing atomizing vapor and pyrolysis oil feed into a catalytic cracking reactor.

### BACKGROUND

Many oil refinery and chemical plant units utilize nozzles for distributing liquid and/or gaseous feed to the unit. In some processes, the ability of the nozzle to distribute the feed to the unit is important to the productivity of the unit. An example of such a process is fluidized catalytic cracking in which large chain hydrocarbon molecules found in crude oil are cracked into smaller and more valuable commercial products such as gasoline range hydrocarbons and diesel oils with the help of catalyst. Typically, hydrocarbons are introduced through feed nozzles in a reactor where the feed is contacted with regenerated particulate solid catalyst. The catalyst selectively aids desirable cracking reactions.

Such a feed nozzle may include an inner tube defining a steam conduit and an outer tube arranged around the inner tube, wherein the outer surface of the inner tube and the inner surface of the outer tube define an annular hydrocarbon conduit, and wherein each of the tubes have an inlet end and an opposite outlet end.

Petroleum hydrocarbon streams such as vacuum gas oil or reduced crude have commonly been upgraded through FCC processes, however, there is an increasing desire to upgrade heat sensitive and/or non-petroleum based hydrocarbons (i.e., renewable and recycled sources) along with the hydrocarbon streams in the FCC processes. By upgrading heat sensitive and/or non-petroleum based hydrocarbons along with the hydrocarbon streams, the resulting upgraded fuel includes a renewable content and enables net petroleum-based hydrocarbon content of the upgraded fuel to be decreased.

Heat sensitive feeds encompass both petroleum and non-petroleum feeds which may be unstable at operating temperatures of many refining/chemical processes. The instability may cause the heat sensitive feeds to polymerize or degrade in the process equipment. Examples of such feeds may include, but are not limited to, products produced from the pyrolysis of biomass, plastics, wastes, and hydrocarbons that contain low boiling components that are volatile near ambient conditions.

Non-petroleum based hydrocarbons encompass biofuels that are derived from organic biomass, and in particular pyrolysis oil, which is also commonly referred to as biomass-derived pyrolysis oil. Pyrolysis oil is produced through pyrolysis, including through recently developed fast pyrolysis processes. Pyrolysis oil is a complex, highly oxygenated organic liquid that typically contains 20-30% by weight water with high acidity (Total acid number (TAN)>10). In other embodiments, pyrolysis oil may be derived from recycled plastics or treated pyrolysis oil, i.e., feeds having low oxygen or low water content.

Pyrolysis oils and/or heat sensitive feeds tend to degrade, coke, foul equipment or prematurely vaporize as the feedstock temperature increases when being injected into the FCC unit. The injection may occur in the riser and/or the fluidized catalyst bed. Prior attempts to co-process pyrolysis oil streams and hydrocarbon streams have involved deoxygenation of the pyrolysis oil. Such an approach adds unit operations, along with added capital costs, to the upgrading process. Feed lines that contain mixtures of a hydrocarbon stream and a pyrolysis oil stream are generally prone to clogging due to the presence of the pyrolysis oil stream in the feed lines.

Modifications to feed nozzles have been explored such that either a coolant stream and/or a mechanical cleaning device are incorporated into the feedstock injector for coking/fouling applications. The coolant stream can be gaseous or liquid and helps to remove heat away from the heat sensitive feedstock. The coking/fouling that may result can be mechanically removed at some frequency with a cleaning device that scours or scrapes the inside surface of the feedstock injector.

However, both modifications have some drawbacks. The coolant streams can negatively impact the mixing of the injected feedstock with the circulating catalyst flowing in the FCC riser, resulting in poor yield structure. Gaseous coolant can add a load to the wet gas compressor which can become a limiting operating parameter to the process. Liquid coolant also requires atomization like the feedstock to achieve good mixing with the catalyst. Both coolant types add complexity to the injector design as well as the piping network for operating the injector.

The mechanical device for removing coke/foulant is operated with a shaft automatically or manually. There is a threat of the device separating from the shaft or the packing around the shaft leaking process material to the atmosphere.

WO2015/119598 describes a feed distributor including a pyrolysis oil feed line and a hydrocarbon feed line having respective outlets into a mixing zone for separately supporting flow of the hydrocarbon stream and the pyrolysis oil stream into the mixing zone. The hydrocarbon stream and the pyrolysis oil stream are mixed in the mixing zone to form a mixture of the pyrolysis oil stream and the hydrocarbon stream. The mixture of the pyrolysis oil stream and the hydrocarbon stream are introduced into a reaction zone, where they are catalytically cracked in the presence of the particulate cracking catalyst.

Accordingly, it is desirable to provide methods and apparatuses that enable a heat sensitive feed and/or mixtures including a heat sensitive feed, such as a pyrolysis oil, and a hydrocarbon stream to be upgraded through catalytic cracking, such as in fluid catalytic cracking units, while avoiding excessive clogging of feed lines.

### SUMMARY

A feed nozzle assembly for co-currently introducing vapor and liquid into a reactor vessel which feed nozzle assembly includes: (a) an annular enclosure surrounding an annular feed conduit, (b) an atomizing vapor conduit surrounded by the annular feed conduit. The annular feed conduit includes a first portion having a first outlet and a second portion having a second outlet opposite the first outlet. The first outlet fluidly connects the first portion and the second portion. The second portion is lined with a non-metallic conduit. The second outlet of the annular feed conduit traverses the annular enclosure. The atomizing vapor conduit has an outlet end having one or more openings disposed upstream of the first outlet of the annular feed conduit.

### BRIEF DESCRIPTION OF THE DRAWINGS

FIG. 1 shows a longitudinal cross-section of a feed nozzle assembly of the invention.

FIG. 2 shows a longitudinal cross-section of the feed nozzle assembly of FIG. 1 inserted within a vessel.

FIG. 3 shows the maximum difference between a wall temperature and the feedstock temperature with the feed nozzle assembly incorporating a non-metallic conduit.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Methods and fuel processing apparatuses for feeding a liquid and vaporous feed to a process is provided herein. In one embodiment, the process of upgrading a heat sensitive stream, such as a pyrolysis oil product stream, are provided herein. As referred to herein, “upgrading” refers to conversion of relatively high boiling point hydrocarbons to lower boiling point hydrocarbons. These feedstocks may be fossil or non-fossil feedstocks. Upgrading processes generally render a heat sensitive stream suitable for use as a transportation fuel and other valuable products, like olefins. In the methods and fuel processing apparatuses described herein, a heat sensitive stream is catalytically cracked in a reaction zone in the presence of a particulate cracking catalyst. The reaction zone, as referred to herein, is an area or space where particulate cracking catalyst is comingled along with the heat sensitive stream. Catalytic cracking is conducted at temperatures in excess of 100° C. In some embodiments, heat sensitive streams may polymerize at temperatures in excess of 25° C. and form deposits within the apparatuses. Deposit formation is of concern in the feed lines that lead to the reaction/riser zone.

Deposit formations in feed lines leading to the reaction zone may result in clogging, which may require shutdown of the fuel processing apparatuses and cleanout of the clogged feed lines. To minimize the temperature rise of the pyrolysis oil stream in accordance with embodiments described herein, the pyrolysis oil stream is insulated in the feed nozzle by a heat shield. In some embodiments, the heat shield surrounds the pyrolysis oil stream helps maintain the temperature of the pyrolysis oil stream at a temperature of less than or equal to about 160° C. substantially up to introduction to the reaction zone. Without wishing to be bound by any particular theory, it is believed that a temperature rise in the pyrolysis oil stream above about 160° C. may result in deposit formation due to polymerization within the pyrolysis oil stream. By maintaining the temperature of the pyrolysis oil stream at a temperature of less than or equal to about 160° C. substantially up to introduction to the reaction zone, deposit formation prior to introducing the pyrolysis oil stream into the reaction zone is minimized at least while the pyrolysis oil stream is within the fuel nozzle outside of the reaction zone, where deposit formation could cause clogging.

In some embodiments, the feed nozzle may be used in a variety of reactor vessels and in a variety of operating modes such as, but not limited to, upflow, downflow, riser or fluidized bed. In some embodiments, the feed nozzle may be used for numerous processes wherein it is desired to have the feed insulated from external sources.

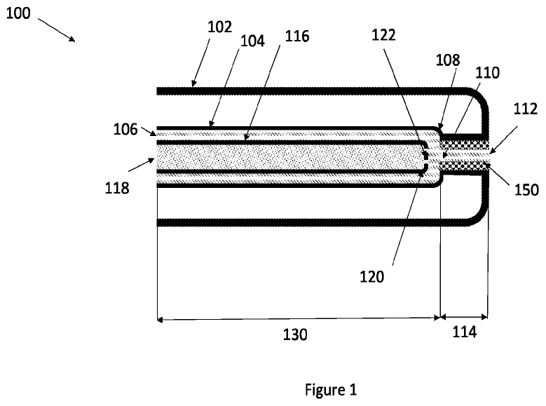

An exemplary embodiment of a feed nozzle will now be addressed with reference to FIG. 1. The feed nozzle assembly 100 includes an annular enclosure 102 surrounding an annular feed conduit 104. The annular feed conduit 104 has a first portion 130 and a second portion 114. In some embodiments, the length of the second portion 114 is less than the length of the first portion 130. In some embodiments, the inner diameter of the second portion 114 may be less than the inner diameter of the first portion 130. In other embodiments, the inner diameter of the second portion 114 may be equal or greater than the inner diameter of the first portion 130. The first portion 130 has an inlet end 106 and an outlet end 108. The outlet end 108 has an opening 110 which fluidly connects the first portion 130 to the second portion 114. The second portion 114 has an outlet 112 opposite the opening 110. The outlet 112 traverses the annular enclosure 102.

The first portion 130 of the annular feed conduit 104 surrounds an atomizing vapor conduit 116. The atomizing vapor conduit 116 has an inlet end 118 and an outlet end 120. The outlet end 120 includes one or more openings 122 from which atomizing vapor exits. In some embodiments, the one or more openings 122 are disposed upstream the opening 110 creating an atomization zone in the outlet end 108 of the annular feed conduit 104 wherein the atomizing vapor atomizes the feed. The length between the one or more openings 122 and the opening 110 can be determined by one skilled in the art.

The inner diameter of the annular enclosure 102 is greater than the outer diameter of the first portion 130 of the annular feed conduit 104. The inner diameter of the annular enclosure 102 is greater than the outer diameter of the second portion 114 of the annular feed conduit 104. The inner diameter of the first portion 130 of the annular feed conduit 104 is greater than the outer diameter of the atomizing vapor conduit 116. In some embodiments, the inner diameter of the second portion 114 is less than or equal to the inner diameter of the atomizing vapor conduit 116. In some embodiments, the inner diameter of the second portion 114 is greater than the inner diameter of the atomizing vapor conduit 116.

The annular enclosure 102 insulates the annular feed conduit 104. The inner diameter of the annular enclosure 102, the outer diameter of the of the annular enclosure 102 and the thickness of the pipe wall can be determined by one skilled in the art. The annular enclosure 102 may be made of materials commonly found in the refining/chemical processing fields, such as, but not limited to, stainless steel or other types of steels. The annular enclosure 102 is hollow and may be filled with one or more insulating materials.

In some embodiments, the insulating material may have a thermal conductivity ranging from 0.0017 to 1.73 watt/(m-° K), from 0.017 to 0.865 watt/(m-° K) or from 0.173 to 0.519 watt/(m-° K). In some embodiments, the insulating material may be gaseous, such as but not limited to, air or an inert gas. The gaseous insulating material may have a thermal conductivity ranging from 0.0173 to 0.432 watt/(m-° K), from 0.0865 to 0.259 watt/(m-° K) or from 0.13 to 0.173 watt/(m-° K). In other embodiments, the air or inert gas in the annular enclosure 102 is removed, creating a vacuum, thereby further reducing the thermal conductivity.

In some embodiments, the annular enclosure 102 may be filled with one or more solid insulating materials. The solid insulating material may have a thermal conductivity ranging from 0.0017 to 1.73 watt/(m-° K), from 0.017 to 1.3 watt/(m-K) or from 0.173 to 0.865 watt/(m-° K). In some embodiments, the insulating materials may be selected from, but not limited to, granulate, heater/boiler insulation, home insulation, etc.

In some embodiments, after the annular enclosure 102 has been filled with the insulating material, a vacuum may be pulled to evacuate any gas remaining in the annular conduit, thus further lowering the thermal conductivity. These thermal conductivity materials may provide at least air-equivalent heat shielding while keeping the equipment design to a smaller scale. Also, these thermal conductivity materials come in a variety of forms (e.g. blanketing, rope, granulate) and can conform to a wide range of annular conduits 102. Installing such materials in an air-containing cavity, gap or annular space will displace volume taken up by air and as a result, limit the pressure build within the equipment as temperatures increase during operation.

The annular feed conduit 104 may be made of materials commonly found in the refining/chemical processing fields which are resistant to acidic liquids, such as but not limited to, stainless steel or other types of steels. The inner diameter of the first portion 130 and the second portion of the annular feed conduit 104, the outer diameter of the first portion 130 and the second portion of the annular feed conduit 104 and the thickness of the pipe wall can be determined by one skilled in the art.

In another embodiment, the second portion 114 surrounds a non-metallic conduit 150. The non-metallic conduit 150 may be cylindrical. In some embodiments, the inner diameter of the non-metallic conduit 150 may be less than or equal to the inner diameter of the atomizing vapor conduit 116. In other embodiments, the inner diameter of the non-metallic conduit 150 may be greater than the inner diameter of the atomizing vapor conduit 116. The inner diameter of the non-metallic conduit 150, the outer diameter of the of the non-metallic conduit 150 and the thickness of the conduit can be determined by one skilled in the art.

The non-metallic conduit 150 may have a thermal conductivity less than the material of the second portion 114. In some embodiments, the non-metallic conduit 150 may be an insulating material or a composite of insulating materials. The insulating material may have a thermal conductivity ranging from 0.0432 to about 3.46 watt/(m-° K), from 0.0865 to 1.73 watt/(m-° K), or from 0.173 to 0.865 watt/(m-° K). In some embodiments, the non-metallic materials may be selected from low thermal conductivity materials, such as but not limited to, ceramics, including examples such as high alumina ceramic and fused silica ceramic. The thermal conductivities for some examples of non-metallic materials are presented in Table 1.

TABLE 1
Thermal Conductivity of common non-metallic materials

| High Alumina Ceramic | | Fused Silica Ceramic | |
|---|---|---|---|
| Temp | Conductivity | Temp | Conductivity |
| (° C.) | [watt/(meter-° K)] | (° C.) | [watt/(meter-° K)] |
| 23.8 | 8.2 | — | — |
| 260 | 5 | 400 | 0.649 |
| 537.7 | 3.6 | 550 | 0.771 |
| 815.5 | 3.1 | 700 | 0.865 |

The atomizing vapor conduit 116 may be made of materials commonly found the refining/chemical processing fields which are resistant to acidic liquids, such as but not limited to, stainless steel or other types of steels. The inner diameter of atomizing vapor conduit 116, the outer diameter of the of atomizing vapor conduit 116 and the thickness of the pipe wall can be determined by one skilled in the art. The number and spacing of the openings 122 can be determined by one skilled in the art.

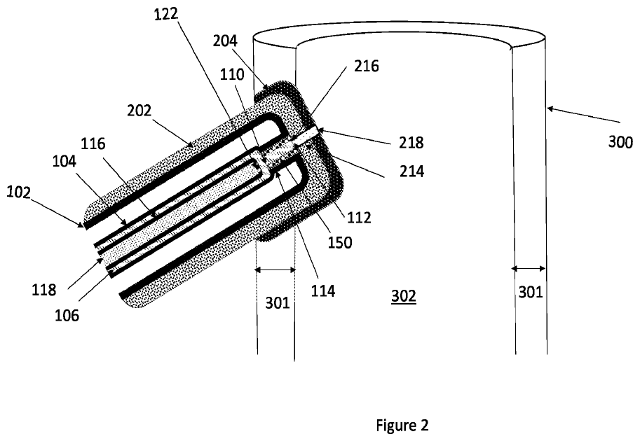

Referring to FIG. 2, in some embodiments, the feed nozzle assembly 100 may be inserted into a vessel 300 having a side wall 301. The vessel 300 may be a reactor or a riser. The side wall 301 thickness may be determined by one skilled in the art. For clarity, the same reference numbers have been used across the Figures to denote the same terms. In some embodiments, the feed nozzle assembly 100 may be inserted into any surface of the vessel 300, i.e., top, bottom or side.

In some embodiments, the feed nozzle assembly 100 is inserted into a nozzle sleeve 202 having a refractory shroud 204 around it. The refractory shroud 204 typically is embedded within the vessel 300 and may or may not extend beyond the side wall 301. In some embodiments, the feed nozzle assembly 100 may be inserted into the vessel 300 without a nozzle sleeve 202. In other embodiments, the feed nozzle assembly 100 may be inserted into any suitable nozzle or suitable opening within the vessel 300. The nozzle sleeve 202 penetrates the side wall 301 into a reaction zone 302. The feed nozzle assembly 100 and the nozzle sleeve 202 are typically oriented at angles ranging from 0 to 90 degrees from horizontal, typically a 45 degree angle from horizontal into the reaction zone 302 as shown in FIG. 2.

The feed nozzle assembly 100 may experience the most severe reactor process conditions if inserted near the main reaction flow path in the reaction zone 302. If the feed nozzle assembly 100 were to be inserted near or adjacent to the main reaction flow path, the feed nozzle assembly 100 would be subjected to less severe conditions, but high heat process conditions, nonetheless. In some embodiments, when the process flow path in the reaction zone 302 is assumed being vertically upward, the underside of the feed nozzle assembly 100 is exposed to reactor zone 302 heat to a larger extent than the upper side of the feed nozzle. The nozzle sleeve 202 and refractory shroud 204 provide some heat shielding for the feed nozzle assembly 100, yet the feed nozzle assembly 100 exposure to heat remains severe.

One of ordinary skill in the art would be able to design and construct the nozzle sleeve 202 to be located within the side wall 301 of the vessel 300. A channel 214 traverses the nozzle sleeve 202 and the shroud refractory 204. The channel 214 provides a fluid conduit from the outlet 112 of the second portion 114 from an inlet 216 to an outlet 218. The outlet 218 is opposite the inlet 216. The outlet 218 of the channel 214 is located within the reactor zone 302. In some embodiments, the nozzle sleeve 202 is composed of a metal, which can be stainless steel and the shroud refractory 204 can be composed of refractory. The composition and size of the nozzle sleeve 202 and refractory shrouding 204 can be determined by one skilled in the art.

During normal operation of the feed nozzle assembly 100 according to embodiments of the present invention, atomizing vapor is passed through the atomizing vapor conduit 116 from the inlet end 118 along the atomizing vapor conduit 116 and exits the atomizing vapor conduit 116 through the openings 122. Pyrolysis oil is supplied to the inlet end 106 of the annular feed conduit 104 and passes along the annular feed conduit 104.

The atomizing vapor exits the one or more openings 122 mixing with the pyrolysis oil in the annular feed conduit 104 resulting in fine jets dispersing the pyrolysis oil. The mixture of atomizing vapor and pyrolysis oil passes through the opening 110 along the non-metallic conduit 150 and exits through the opening 112 of the annular enclosure 102. The one or more openings 122 are adapted to substantially uniformly atomize the mixture of atomizing vapor and pyrolysis oil prior to entering the opening 110. In some embodiments, the opening 112 is aligned with the channel 214 to exit into the vessel 300 via the outlet 218. The vessel may be, but is not limited to, a fluid catalytic cracking reactor.

The pyrolysis oil in the second portion 114 is shielded from the heat of the vessel 300 by the non-metallic conduit 150. The heat shielding capability of the non-metallic conduit 150 for a non-metallic insulating material was evaluated in the following examples.

For the analysis, the annular enclosure 102 was filled with granulate material having the thermal conductivity as shown in Table 2:

TABLE 2
Thermal Conductivity of Granulate materials

| Granulate | |
|---|---|
| Temperature | Conductivity |
| (° C.) | [watt/(meter-° K)] |
| 200 | 0.0225 |
| 400 | 0.0277 |
| 600 | 0.0346 |
| 800 | 0.0432 |

In Example 1, finite element analysis was conducted to predict the thermal gradients of specific feed nozzle internal surfaces under various process operating conditions. Of most interest were those temperatures of the internal surfaces of the non-metallic conduit 150 in contact with the above-described heat sensitive feedstocks. Shielding the internal surfaces of the non-metallic conduit 150 from reaching excessive temperatures may mitigate potential coking and fouling of the heat sensitive feedstock within the feed nozzle assembly 100. In other words, the heat shielding provided by the non-metallic conduit 150 minimizes the difference between the heat sensitive feedstock inlet temperature at the inlet end 106 and the surface temperatures of internal contact surfaces, such as the annular feed conduit 104, the outlet end 108, the opening 110, the non-metallic conduit 150 and the outlet 112.

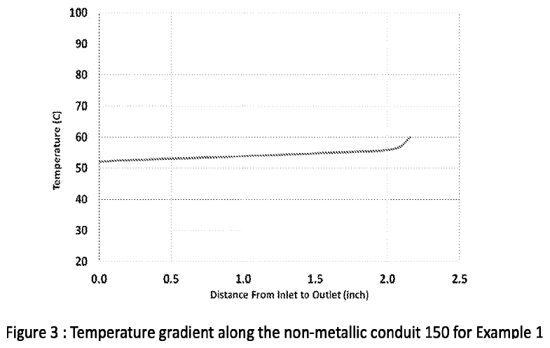

Referring to FIG. 1, the feed nozzle assembly 100 was modeled such that the temperature of the heat sensitive feedstock entering the opening 110 could be compared to predicted wall temperatures distributed along non-metallic conduit 150 to outlet 112. The annular enclosure 102 was modeled to be filled with granulate material having the properties shown in Table 2. In one example, the annular enclosure 102 exposed to a process vapor having a temperature of about 345° C. For a typical feed nozzle assembly 100 operating range, the maximum temperature difference between any predicted non-metallic conduit 150 wall temperature along its length and the heat sensitive feedstock temperature entering the opening 110 was approximately 8° C. (see FIG. 3). This low temperature increase enables the heat sensitive feedstock to be maintained at a temperature of less than or equal to about 160° C. up to introduction into the reaction zone 302.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A feed nozzle assembly for co-currently introducing vapor and liquid into a reactor vessel which feed nozzle assembly comprises:
(a) an annular enclosure surrounding an annular feed conduit,
(b) an atomizing vapor conduit surrounded by the annular feed conduit,
wherein the annular feed conduit comprises a first portion having a first outlet and a second portion comprising a second outlet opposite the first outlet, the first outlet fluidly connecting the first portion and the second portion,
wherein the second portion is lined with a non-metallic conduit,
wherein the second outlet of the annular feed conduit traverses the annular enclosure, and
wherein the atomizing vapor conduit has an outlet end comprising one or more openings disposed upstream of the first outlet of the annular feed conduit.

2. The feed nozzle assembly of claim 1, wherein the inner diameter of the second portion of the annular feed conduit is less than or equal to the inner diameter of the first portion of the annular feed conduit.

3. The feed nozzle assembly of claim 1, wherein the inner diameter of the second portion of the annular feed conduit is greater than or equal to the inner diameter of the first portion of the annular feed conduit.

4. The feed nozzle assembly of claim 1, wherein the length of the second portion of the annular feed conduit is less than or equal to the length of the first portion of the annular feed conduit.

5. The feed nozzle assembly of claim 1, wherein the inner diameter of the annular enclosure is greater than the outer diameter of the annular feed conduit.

6. The feed nozzle assembly of claim 1, wherein the inner diameter of the first portion of the annular feed conduit is greater than the outer diameter of the atomizing vapor conduit.

7. The feed nozzle assembly of claim 1, wherein the inner diameter of the second portion of the annular feed conduit is less than or equal to the inner diameter of the atomizing vapor conduit.

8. The feed nozzle assembly of claim 1, wherein the non-metallic conduit has a thermal conductivity ranging from about 0.173 to about 3.46 watt/(m-° K).

9. The feed nozzle of claim 8, wherein the non-metallic conduit is high alumina ceramic.

10. The feed nozzle of claim 8, wherein the non-metallic conduit is fused silica ceramic.
